(19) United States
(12) Patent Application Publication
(10) Pub. No.: US 2002/0032020 A1
(43) Pub. Date: Mar. 14, 2002

(54) Local and remote email alert apparatus and methods

(76) Inventors: Bonnie L. Brown, Alpine, CA (US); Craig L. Linden, Alpine, CA (US)

Correspondence Address: CRAIG L. LINDEN, 1335 MIDWAY DR., ALPINE, CA, 91901, US

(21) Appl. No.: 09/854,314

(22) Filed: May 12, 2001

Related U.S. Application Data
(60) Provisional application No. 60/203,876, filed on May 12, 2000.

(51) Int. Cl. H04M 11/10

(52) U.S. Cl. 455/414; 455/412

(57) ABSTRACT

New or improved apparatus, systems, services and business methods relating to alerting persons of information, events, etc., for instance such as incoming email, messages, reminders, etc. For example, when a local computer (1) or other connected device receives an email or other information from source (4) related information is transmitted via (5) to one or more display capable devices (2) thereby, for instance, alerting and/or providing such information to, for instance, a remotely located person. These devices, methods, systems and/or services can optionally be programmed or be instructed to prioritize the level, frequency and/or type of sound, light, color and/or tactile stimulation, for instance, according to the level of email importance, etc. One or a plural of methods, services and/or devices may optionally be used concurrently to maximize the success of timely notification, etc. The disclosed devices, methods and/or services may be applied and/or integrated into various devices and communication systems, such as home/office computers, mobile computers, PDAs, phones, pagers, MP3s, SmartPhones, Web enabled TVs, iTVs, eTVs, iRadios, combination devices and other devices, etc.

### CROSS REFERENCES TO RELATED APPLICATIONS

This application is related to U.S. Provisional Patent Application Ser. No. 60/203,876, filed May 12, 2000, on behalf of Bonnie Linden Brown (herein, Brown, Bonnie, L.) and titled “REAS” ˜ Local and/or Remote Email Alert Stations or Systems.

### BACKGROUND—FIELD OF INVENTION

This invention relates generally to new or improved devices, systems and business methods relating to alerting persons, who for instance may not be near their computer, of incoming or receipt notice of outgoing email. Herein, the term email may be used to broadly apply to PC-based email, non-PC-based email, other text-based messaging such as IM, SMS, etc., voice messaging and/or tactile messaging. The word “method” herein will generally be used in place of one or more of the following terms: message alert services, business services, business concepts, business methods, business model, etc.

These improvements in devices, services and methods (new and/or as applied and/or incorporated into additional functionality to prior art devices) are accomplished through the inventive integration and/or mixing and matching of various stationary and mobile computer and communication platforms, the Internet, intranets, extranets, software, wireless and wired devices (lights, strobes, video, pictorial, audible devices and tactile technologies, such as vibration, digital displays, smell producing devices, etc.) fax machines and even location technologies and devices such as GPS, etc. when appropriate.

Various forms of the invention are intended to overcome limitations related to the prior art. Although this application will primarily apply to email alert platforms, other communication platforms and methods are included when the inventive combinations and/or new methods proposed herein represent advancement in the state of the art. The devices may repeat or forward (one-way or two-way) information to other similar or dissimilar devices and platforms. The devices may be also equipped with such means as to provide recording, amplification, for antennas, receivers, transceivers, power sources (external or internal), cancellation means, etc.

### BACKGROUND—DESCRIPTION OF PRIOR ART

Although not so limited, this invention generally relates to alerting persons when they receive email messages, etc. Herein, the term “prior art” shall mean, both the historical prior art prior to this invention, and also art, which became available or known later. Historically, factories and other facilities have used wired-in-place devices such as loud sound buzzers and/or light devices, etc. to alert personal of phone calls, visitors, etc. Walkie-talkies, pagers, mobile phones and other wireless communication devices use audible rings, tones, music sounds and/or vibration to alert persons of incoming voice calls or text messages. Until recently, as mentioned below, these examples of prior art devices and systems were not used to alert and/or forward PC-based email to persons remotely located from PC-based email devices.

The majority of the email alert related prior art requires a person to be near her or his computer monitor, Web enabled TV or other email enabled or connected communication device to learn whether or not a new message has arrived. However, more recently, as mentioned above, there are companies such as etrieve and others, that use various technologies for notifying and delivering PC-based (the term “PC” herein broadly applies to other types of computers and related systems) email messages (or portions, thereof) across different platforms by employing servers and various mobile phone text technologies and/or text-to-voice technologies, etc. America Online, Inc. (AOL) announced their new AOL Mail Alerts service on Jan. 8, 2001. The AOL new alert service is also a cross-platform service, allowing a user of a mobile phone or pager to receive notice and review, on a small mobile screen email that would otherwise only be available via a PC.

There are many Windows and other software-based email notification tools that can handle multiple e-mailboxes. Many of the software programs are freeware or shareware. Maillt, for instance, is a freeware email notifying PC-based program for people that receive a lot of email. Maillt and some other programs have mechanisms to separate important email from the unimportant. Many of the programs also provide antispam and antivirus filters, etc.

Although not intended to list all the disadvantages related to the prior art, generally the prior art email alert or notification apparatus, systems and methods require one to be near the PC in order to view visual indicators on the monitor or in limited cases, a small LED, etc., which may built into the keyboard, etc. Such systems may also provide an audible tone for incoming email, etc. More recently, as mentioned above, some firms provide remote email forwarding, alerts and mail review capabilities to mobile devices, so that a person can stay in touch with his important email communications while away from his PC, etc.

However, the inventors know of no mobile or wired alert only devices, methods or services, which provide one or plural distinct sensible alerts, which can be used with various types of available email software. The disclosed email alert devices, systems, and/or methods are intended provided improved alerts to mobile persons via a single or plural of their senses via pagers, wired and mobile phones, RF enabled pendants, watches, other wearable devices, distributed lights, noisemakers, and/or tactile interaction. Importantly, the single or plural sensible outputs can be variable so as to communicate information, via the alert itself, i.e. without reading, listening, or feeling the actual message. For example, the invention will allow a person to be alerted to the degree of importance of the incoming message, the sender and the type of message (PC-based, IM, SMS, phone, VoIP, etc.) etc. Therefore, one can see that the disclosed inventions, services and/or methods allow much more alert information to be transmitted as compared to the prior art's limited use of single ring tones, music, distinctive ring tones, limited tactile alarms, and its limited use of lights, buzzers and other audible devices, etc.

### SUMMARY

In accordance with the present invention various email alert devices, methods, services and combinations are disclosed. Single and/or multiple user-based alert devices, etc. and single and/or cross-platform devices and/or systems are disclosed. These devices, methods, systems and/or services can optionally use software to prioritize the level, frequency and/or type of sound, light, color and/or tactile stimulation according to the level of email importance pre-selected by the user (or as preprogrammed). One or a plural of methods, services and/or devices may optionally be used concurrently to maximize the success of timely notification.

### Objects and Advantages

Although not so limited, the general object of the present invention is to propose new and improved apparatus, services and/or methods related to alerting persons to email events, who, for whatever reason desire a more widely available, timely, convenient and relatively inexpensive email notification device and/or services. The disclosed devices, methods and/or services may be applied to various email enabled devices, such as home/office computers, mobile computers, PDAs, phones, MP3s, SmartPhones, Web enabled TVs, iTVs, iRadios, combination devices and other related devices.

Mostly these email events will be related to pre-selected incoming emails or to a notification that message(s) the user transmitted was received or not received, etc. Additionally, the use of special alert tones, tactile and/or visual alerts are disclosed to alert users of the safety of loved ones, special advertising, online/mobile single or multiplayer game events (or turns) coupons, special promotions, social events, traffic, weather and/or emergency conditions etc. When provided by third parties, the specialized sense alerts may or may not be opt-in, i.e., voluntarily agreed to be received by the user. Any and all of the services and devices disclosed herein may be sold or provided free or provided on a per use basis or monthly fee. Certain types of content and in certain situations money, prizes, discounts, or other rewards may be provided to the users.

One or a plural of single or multi-colored lights and/or variable and/or non-variable sounds and/or variable and/or non-variable tactile and/or actual or computer voice alerts for distribution in rooms or areas near and/or remote from the computer, etc. can be wired, wireless (RF, laser, IR, etc.). The units may be made to plug into electrical outlets to take advantage of the existing building wiring system by using the wiring to carry signals. Similarly, the units may be made to plug into or connect wirelessly to the phone or other types of communication systems. New types of wired and mobile phones that perform conventional phone functions and/or voice-over-IP (VoIP) and also perform one or more of the sense alert functions disclosed herein.

### DESCRIPTION OF THE DRAWINGS

FIG. 1 is a combination pictorial and block diagram representing the local and/or remote distribution of home or office email or other message event alerts received by computer 1, which is wireless and/or wired connected via 5 to a service provider 4. The devices 2 receive the alert information from 1 via wireless or/or wired one-way or two-way connections 3 and emit one or a plural of variable or fixed sounds, lights, colors and/or tactile information.

FIG. 2 is a combination pictorial and block diagram representing the local and/or remote wireless (RF, laser, IR, etc.) Distribution via 5 of email or other message event alerts from a local connected computer 1 or remote service server 4 to device 6. Device 6 may be on or a plural devices. Device 6 may also be one or a plural of types of wireless one-way or two-way communication devices. Device 6 may provide one or a plural of sensible outputs, which communicate more alert information than the prior art (as set forth herein).

The foregoing descriptions of specific and suggested embodiments of the present invention have been presented for purposes of illustration and description only. The embodiments were chosen, drawn and described in order to best explain and illustrate, in an economical manner, the basic improvements of the invention and at least one of its practical applications. Many known and common platforms may be adapted or integrated with the present invention. Illustrations of common un-enhanced wired and mobile devices and platforms devices discussed herein, are available elsewhere therefore, the preparation of additional drawings showing more examples has been avoided.

This document is meant to be read and understood as a whole, and where useful along with the mentioned provisional patent application, thereby if some descriptive point or other information is presented in one area but not another, such information and descriptions are to be applied generally as appropriate to other discussions and descriptions. The necessary components, materials and software to enable any and all of the proposed methods are available. Thereby, with the such available building blocks, along with wise and experienced experts and technicians in computer, electronics, ISP, mobile communications systems, GPS with those with expert advertising, marketing, finance, appropriate business knowledge, and the descriptions herein, thereby enabling such a team to best utilize the inventive methods and various embodiments with various modifications as are suited to the particular platform use, area and markets contemplated. Accordingly, the scope of the invention is defined by the claims appended hereto and their equivalents.

What is claimed is:

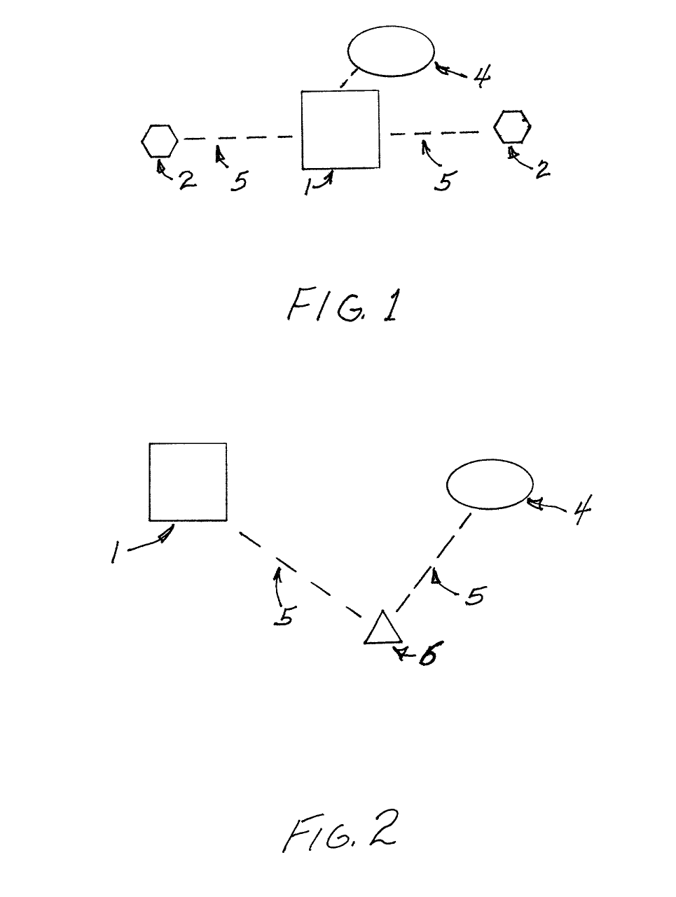

1. Email alert devices comprised of:
(a) an energy source means, local or remote;
(b) communication means to a local or remote message source;
(c) one or more sensible means to alert a person that a message has arrived,
whereby for example only, one or a plural of such devices may be placed in various locations, and when a new email arrives to a connected computer or other message receiving apparatus, an appropriate signal is transmitted to the alert device(s), which then outputs one or more sensible alert(s) as generally represented by FIG. 1.

2. Email alert devices as recited in claim 1, further comprised of sensible means to provide one additional piece of information associated with the message,
whereby for example only, one or a plural of such devices may be placed in various locations, and when a new email arrives to a connected computer or other message receiving apparatus, appropriate signals are transmitted to the alert device(s), which then outputs one or more sensible alert(s) and also provide one additional piece of information, such as the sender's identification, type of message, priority, etc. as generally represented by fig 1.

3. Email alert devices as recited in claim 1, further comprised of sensible means to provide two additional pieces of information associated with the message,
whereby for example only, one or a plural of such devices may be placed in various locations, and when a new email arrives to a connected computer or other message receiving apparatus, appropriate signals are transmitted to the alert device(s), which then outputs one or more sensible alert(s) and also provides two additional pieces of information, such as the sender's identification, type of message, priority, etc. as generally represented by FIG. 1.

4. Email alert devices as recited in claim 1, further comprised of sensible means to provide three or more additional pieces of information associated with the message, whereby for example only, one or a plural of such devices may be placed in various locations, and when a new email arrives to a connected computer or other message receiving apparatus, appropriate signals are transmitted to the alert device(s), which then outputs one or more sensible alert(s) and also provides three or more additional pieces of information, such as the sender's identification, type of message, priority, etc. as generally represented by FIG. 1.

5. Email alert devices as recited in claim 1, further comprised of one or more means to display messages and any attachments or a portion of the messages,
whereby for example only, one or a plural of such devices may be placed in various locations, and when a new email arrives to a connected computer or other message receiving apparatus, appropriate signals are transmitted to the alert device(s), which then outputs one or more sensible alert(s) and also displays (visually, print, and/or by voice, etc.) the message, etc. as generally represented by FIG. 1.

6. Message alert devices comprised of:
(a) an energy source means, local or remote;
(b) communication means to a local or remote message source;
(c) one or more sensible means to alert a person that a message has arrived,
whereby for example only, one or a plural of such devices may be placed in various locations, and when a new message arrives to a connected computer or other message receiving apparatus, an appropriate signal is transmitted to the alert device(s), which then outputs one or more sensible alert(s) as generally represented by FIG. 1.

7. Message alert devices as recited in claim 6, further comprised of sensible means to provide one additional piece of information associated with the message,
whereby for example only, one or a plural of such devices may be placed in various locations, and when a new message arrives to a connected computer or other message receiving apparatus, appropriate signals are transmitted to the alert device(s), which then outputs one or more sensible alert(s) and also provide one additional piece of information, such as the sender's identification, type of message, priority, etc. as generally represented by FIG. 1.

8. Message alert devices as recited in claim 6, further comprised of sensible means to provide two additional pieces of information associated with the message,
whereby for example only, one or a plural of such devices may be placed in various locations, and when a new message arrives to a connected computer or other message receiving apparatus, appropriate signals are transmitted to the alert device(s), which then outputs one or more sensible alert(s) and also provides two additional pieces of information, such as the sender's identification, type of message, priority, etc. as generally represented by FIG. 1.

9. Message alert devices as recited in claim 6, further comprised of sensible means to provide three or more additional pieces of information associated with the message,
whereby for example only, one or a plural of such devices may be placed in various locations, and when a new message arrives to a connected computer or other message receiving apparatus, appropriate signals are transmitted to the alert device(s), which then outputs one or more sensible alert(s) and also provides three or more additional pieces of information, such as the sender's identification, type of message, priority, etc. as generally represented by FIG. 1.

10. Message alert devices as recited in claim 6, further comprised of one or more means to display messages and any attachments or a portion of the messages,
whereby for example only, one or a plural of such devices may be placed in various locations, and when a new message arrives to a connected computer or other message receiving apparatus, appropriate signals are transmitted to the alert device(s), which then outputs one or more sensible alert(s) and also displays (visually, print, and/or by voice, etc.) the message, etc. as generally represented by FIG. 1.

11. Non PC-based mobile devices for alerting users of PC-based messages comprised of:
(a) an energy source means;
(b) a wireless communication means to a local or remote server or other source;
(c) one or more sensible means to alert a person that a message has arrived;
whereby for example only, one or a plural of such devices may carried or worn or be placed in various locations, and when a new PC-based message arrives to a remote server, connected computer or other message receiving apparatus, appropriate signals are transmitted to the alert device(s), which then outputs one or more sensible alert(s) as generally represented by FIG. 2.

12. Non PC-based mobile alert devices as recited in claim 11, further comprised of sensible means to provide one additional piece of information associated with the message,
whereby for example only, one or a plural of such devices may carried or worn or be placed in various locations, and when a new PC-based message arrives to a remote server, connected computer or other message receiving apparatus, appropriate signals are transmitted to the alert device(s), which then outputs one or more sensible alert(s) and also provides an additional piece of information, such as the sender's identification, type of message, priority, etc. as generally represented by FIG. 2.

13. Non PC-based mobile alert devices as recited in claim 11, further comprised of sensible means to provide two or more additional pieces of information associated with the message,
whereby for example only, one or a plural of such devices may carried or worn or be placed in various locations, and when a new PC-based message arrives to a remote server, connected computer or other message receiving apparatus, appropriate signals are transmitted to the alert device(s), which then outputs one or more sensible alert(s) and also provides two or more additional piece of information, such as the sender's identification, type of message, priority, etc. as generally represented by FIG. 2.

14. Non PC-based mobile alert devices as recited in claim 11, further comprised of sensible means to display the message and any attachments or a portion of the messages,
whereby for example only, one or a plural of such devices may carried or worn or be placed in various locations, and when a new PC-based message arrives to a remote server, connected computer or other message receiving apparatus, appropriate signals are transmitted to the alert device(s), which then outputs one or more sensible alert(s) and also displays (visually, print, and/or by voice, etc.) the message, etc. as generally represented by FIG. 2.

15. Mobile devices for alerting users of arriving messages comprised of:
(a) an energy source means;
(b) a wireless communication means to a local or remote server or other source;
(c) one or more sensible means to alert a person that a message has arrived;
whereby for example only, one or a plural of such devices may carried or worn or be placed in various locations, and when a message arrives to a remote server, connected computer or other message receiving apparatus, appropriate signals are transmitted to the alert device(s), which then outputs one or more sensible alert(s) as generally represented by FIG. 2.

16. Mobile alert devices as recited in claim 15, further comprised of sensible means to provide one additional piece of information associated with the message,
whereby for example only, one or a plural of such devices may carried or worn or be placed in various locations, and when a message arrives to a remote server, connected computer or other message receiving apparatus, appropriate signals are transmitted to the alert device(s), which then outputs one or more sensible alert(s) and also provides an additional piece of information, such as the sender's identification, type of message, priority, etc. as generally represented by FIG. 2.

17. Mobile alert devices as recited in claim 15, further comprised of sensible means to provide two or more additional pieces of information associated with the message,
whereby for example only, one or a plural of such devices may carried or worn or be placed in various locations, and when a message arrives to a remote server, connected computer or other message receiving apparatus, appropriate signals are transmitted to the alert device(s), which then outputs one or more sensible alert(s) and also provides two or more additional piece of information, such as the sender's identification, type of message, priority, etc. as generally represented by FIG. 2.

18. Mobile alert devices as recited in claim 15, further comprised of sensible means to display the message and any attachments or a portion of the messages,
whereby for example only, one or a plural of such devices may carried or worn or be placed in various locations, and when a message arrives to a remote server, connected computer or other message receiving apparatus, appropriate signals are transmitted to the alert device(s), which then outputs one or more sensible alert(s) and also displays (visually, print, and/or by voice, etc.) the message, etc. as generally represented by FIG. 2.

19. Alert devices, or functional portions necessary thereof, as recited in claims 1 through 18, for integration into common devices, such as mobile phones, wired phones, wireless phones, PDAs, various mobile devices, MP3s, laptops, radios, TVs, Web TVs, computers, etc.,
whereby for example only, such integrated devices may better alert persons to messages and/or better display such messages.

20. Business method means and service means to provide services and establish Internet and other related businesses related to the devices and related message services claimed in claims 1 through 19.
